(19) United States
(12) Patent Application Publication
(10) Pub. No.: US 2013/0085745 A1
(43) Pub. Date: Apr. 4, 2013

(54) SEMANTIC-BASED APPROACH FOR IDENTIFYING TOPICS IN A CORPUS OF TEXT-BASED ITEMS

(71) Applicant: Salesforce.com, Inc., San Francisco, CA (US)

(72) Inventors: Jari Koister, Menlo Park, CA (US); Antonisamy Arokiasamy, Freemont, CA (US); Kasthuri Periyakoil, San Francisco, CA (US); Marcus Ericsson, San Francisco, CA (US)

(73) Assignee: SALESFORCE.COM, INC., San Francisco, CA (US)

(21) Appl. No.: 13/632,848

(22) Filed: Oct. 1, 2012

Related U.S. Application Data
(60) Provisional application No. 61/543,134, filed on Oct. 4, 2011.

(51) Int. Cl. G06F 17/27

(52) U.S. Cl. 704/9

(57) ABSTRACT

A method of identifying topics in a corpus that includes a plurality of text-based items begins by extracting keytext from each of the plurality of text-based items, resulting in sets of keytext. The method continues by processing the keytext sets to generate a respective semantic footprint for each of the text-based items, resulting in a plurality of semantic footprints. The semantic footprints are used to calculate similarity values for the text-based items, wherein the similarity values indicate commonality between pairs of the text-based items. The method continues by clustering the text-based items into a number of topic groups, wherein the clustering is influenced by the similarity values, and by generating a topic heading for each of the number of topic groups, resulting in a number of topic headings. Next, the text-based items are grouped into accessible topic groups associated with the topic headings.

### CROSS-REFERENCE TO RELATED APPLICATION

This application claims the benefit of U.S. provisional patent application No. 61/543,134, filed Oct. 4, 2011.

### TECHNICAL FIELD

Embodiments of the subject matter described herein relate generally to the processing of text-based content maintained by a computer implemented system, such as a social networking system. More particularly, the subject matter relates to a technique for identifying contextual topics in a corpus of text-based items, where the items may be posts, comments, messages, or other information entered by users of a social networking system.

### BACKGROUND

Social networking applications, systems, and services are becoming increasingly popular. An online consumer based social network application (such as the FACEBOOK social network application or the TWITTER social network application) can be customized for use by a private enterprise. Alternatively, a social network application can be specifically designed and configured for use in an enterprise environment. Social networks often handle large amounts of data for each user, because each user can contribute, collaborate, and share information with other social network users. In the enterprise environment, this information can include postings on the status of a deal or project, short summaries of what the posting user is doing, and/or public online conversations about a certain topic on a feed or “wall.”

It may be desirable to categorize or group related or similar user-generated content into topics. In this regard, user posts or comments maintained by a social networking system can be analyzed to identify certain topics, and relevant content can be organized and associated with the respective topic(s). Topic extraction or identification could also be utilized in other applications where a collection or corpus of text-based items are maintained.

Conventional topic identification approaches employ user-generated content tagging and statistics as a means to identify the “likeness” of textual data. These techniques can be fairly successful in certain settings. For example, the statistical model can be quite successful in a high data volume setting where the statistical significance of predictions and/or classifications can be demonstrated rather easily and convincingly. User-generated tags or topics may also be quite successful in domains where user activity is high. These two scenarios, however, are not always found in an enterprise environment where vast amounts of data are not being evaluated, where the specific needs of each enterprise are different from other enterprises, and where numerous different users are viewing the information from different perspectives. Thus, a different approach could be utilized to address these and other issues.

Accordingly, it is desirable to have a topic extraction methodology that is suitable for an enterprise setting, and that addresses the shortcomings of conventional methodologies. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a schematic representation of an exemplary embodiment of a computer-implemented system;

FIG. 2 is a diagram that schematically depicts an exemplary methodology for generating a semantic footprint from a text-based item;

FIG. 3 is a flow chart that illustrates an exemplary embodiment of a topic identification process;

FIG. 4 is a schematic rendering of a screen shot that includes a list of selectable topic headings;

FIG. 5 is a schematic rendering of a screen shot that includes a group of posts associated with a selected topic; and

FIG. 6 is a schematic representation of an exemplary embodiment of a multi-tenant application system.

### DETAILED DESCRIPTION

The exemplary embodiments presented here relate to a computer-implemented system and methodology that identifies topics or subjects from unstructured data (such as posts, messages, or blogs associated with a social networking application) using a semantic paradigm. The tools and techniques described here include a process for utilizing semantic information of textual data to identify similarities among documents and other contextual information, to group them based on their similarities, and to identify latent topics that are embedded in these documents and other contextual information.

In accordance with one exemplary embodiment, the tools and techniques described herein are suitable for use in an environment that has a relatively low number of users (some enterprises may contain less than ten users). The described approach is suitable for use in an environment where a very small portion of the users are “actively” posting content while the majority are either passive or lurkers. In some arenas, this is known as the “one percent” rule, which refers to the number of active users or posters at any given time.

An implementation takes documents and/or other information in a corpus and runs the data through an efficient similarity algorithm to create a similarity graph that is indicative of a level of similarity between documents, posts, messages, or pieces of content. The graph is then utilized to group the information based on a grouping algorithm (such as the DBSCAN data clustering algorithm) in a parallelized environment such as the HADOOP software framework. Once the groups are created, a topic extraction algorithm is used to identify topics in these groups. The topic extraction algorithm uses semantics in its comparisons and calculations. It also may include and use an enterprise-specific ontology to glean semantic information from the texts. A number of exemplary semantic topics derived using these techniques for a specific enterprise organization are presented below.

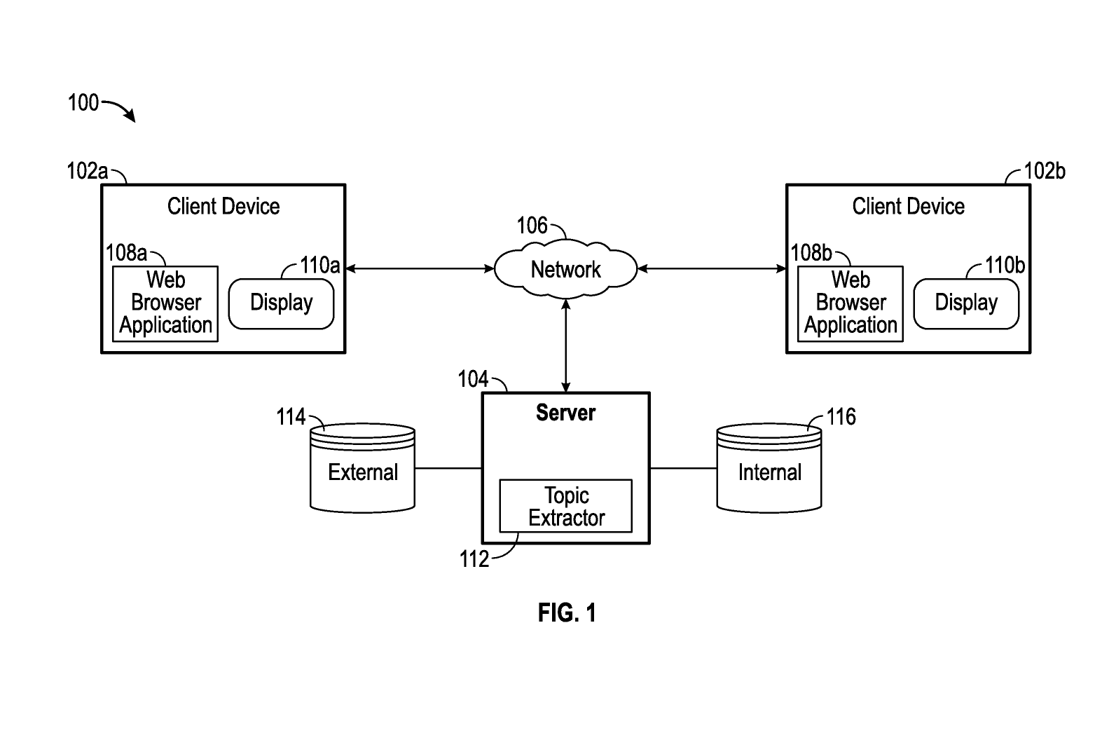

Referring now to the drawings, FIG. 1 is a schematic representation of an exemplary embodiment of a computer-implemented system 100. Although certain embodiments described here relate to a web-based system, the techniques and methodologies can be utilized in other types of network arrangements. Moreover, the simplified system 100 shown and described here represents only one possible embodiment of a system for identifying topics in a corpus of text-based items. The illustrated embodiment of the system 100 includes at least one client device 102 and a server 104 operatively coupled to each other through a data communication network 106. The system 100 is preferably realized as a computer-implemented system in that the client devices 102 and the server 104 are configured as computer-based electronic devices.

Although FIG. 1 depicts two client devices 102 and only one server 104, an embodiment of the system 100 could support any number of client devices and any number of server devices. Each client device 102 supported by the system 100 may be implemented using any suitable hardware platform. In this regard, a client device 102 may be realized in any common form factor including, without limitation: a desktop computer; a mobile computer (e.g., a tablet computer, a laptop computer, or a netbook computer); a smartphone; a video game device; a digital media player; a piece of home entertainment equipment; or the like. Each client device 102 supported by the system 100 is realized as a computer-implemented or computer-based device having the hardware, software, firmware, and/or processing logic needed to carry out the processes described in more detail herein. For example, each client device 102 may include a respective web browser application 108 (having conventional web browser functionality) that facilitates the rendering of web pages, images, documents, and other visual content at a display element 110. The display element 110 may be incorporated into the client device 102 itself (for example, if the client device 102 is implemented as a tablet computer or a smartphone device), or it may be realized as a physically distinct component that is operatively coupled to the client device 102, as is well understood.

The server 104 can be deployed in certain embodiments of the system 100 to manage, handle, and/or serve some or all of the text-related functionality of the client devices 102, such as the processing of user-entered posts, messages, articles, blogs, and the like. In this regard, the server 104 may include web server functionality to generate and provide web pages and/or other hypertext markup language (HTML) documents to the client devices 102 as needed. Moreover, the server 104 is suitably configured to manage, handle, and perform the various topic identification tasks described in more detail below. In practice, the server 104 may be realized as a computer-implemented or computer-based system having the hardware, software, firmware, and/or processing logic needed to carry out the various techniques and methodologies described in more detail herein. It should be appreciated that the server 104 need not be deployed in embodiments where the client devices 102 perform the desired functionality. In other words, the methodology described herein could be implemented at the local client device level without relying on any centralized processing at the server level. Moreover, in certain embodiments the desired functionality could be executed or performed in a distributed manner across the server 104 and one or more of the client devices 102.

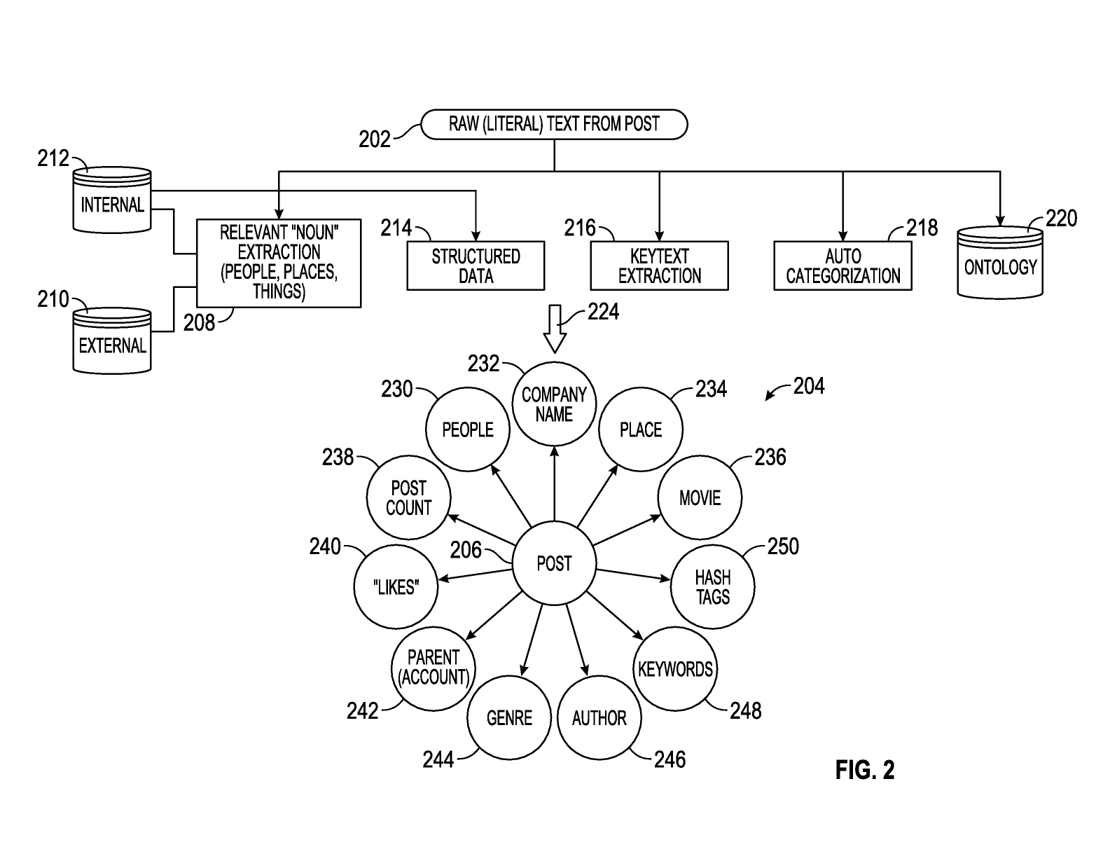

The system 100 includes a topic extractor 112 implemented at the server 104 (as shown in FIG. 1), at the client device 102, or distributed across multiple computer-based components of the system 100. The topic extractor 112 is responsible for accessing and processing text-based items that are maintained by the system 100, where such text-based items are typically user-entered or user-submitted content generated at the client devices 102. In this regard, the topic extractor 112 processes text-based items that are maintained by the system, derives semantic footprints for the text-based items, and processes the semantic footprints to group the text-based items into relevant topic groups. Although not always required, the topic extractor 112 may include or cooperate with an ontology extractor that is suitably configured to apply ontology-based techniques during the analysis of the text-based items and/or during the creation of topic headings for the topic groups. The ontology extractor may be associated with one or more ontology trees, which may be generated and maintained by the host system itself, or which may be obtained from an outside source, a vendor, or any third party provider. As explained in more detail below with reference to FIG. 2, the ontology extractor can be utilized to increase the accuracy and contextual relevancy of the topic extraction routine.

The topic extractor 112 may be implemented by hardware, software, firmware, and/or processing logic that supports various topic extraction and identification operations. For example, the functionality of the topic extractor 112 may be provided in the form of a non-transitory computer-readable medium that resides at the server 104, where the computer-readable medium includes computer-executable instructions that, when executed by a processor of the server 104, perform the various topic extraction tasks that result in the identification of relevant topics for the text-based items.

Although not always required, the system 100 may include or cooperate with one or more databases associated with the server 104. The exemplary embodiment shown in FIG. 1 includes at least one external database 114 and at least one internal database 116. The external database 114 is “external” from the standpoint of the system 100 or the host application (e.g., a social networking system) that is responsible for maintaining the text-based items. For example, the external database 114 could be maintained by a third party, an outside vendor, or any entity that allows the system 100 to gain access to the external database 114. In contrast, the internal database 116 is “internal” in that it can be considered to be part of the system 100 itself. In certain situations, the system 100 accesses the content of one or more of the databases 114, 116 to determine how best to characterize the text-based items for purposes of topic extraction (as described in more detail below with reference to FIG. 2). Alternatively or additionally, the databases 114, 116 could provide system-specific or enterprise-specific ontology trees or other ontology related information to the topic extractor 112 or to an ontology extractor of the server 104.

The data communication network 106 provides and supports data connectivity between the client devices 102 and the server 104. In practice, the data communication network 106 may be any digital or other communications network capable of transmitting messages or data between devices, systems, or components. In certain embodiments, the data communication network 106 includes a packet switched network that facilitates packet-based data communication, addressing, and data routing. The packet switched network could be, for example, a wide area network, the Internet, or the like. In various embodiments, the data communication network 106 includes any number of public or private data connections, links or network connections supporting any number of communications protocols. The data communication network 106 may include the Internet, for example, or any other network based upon TCP/IP or other conventional protocols. In various embodiments, the data communication network 106 could also incorporate a wireless and/or wired telephone network, such as a cellular communications network for communicating with mobile phones, personal digital assistants, and/or the like. The data communication network 106 may also incorporate any sort of wireless or wired local and/or personal area networks, such as one or more IEEE 802.3, IEEE 802.16, and/or IEEE 802.11 networks, and/or networks that implement a short range (e.g., Bluetooth) protocol.

In practice, the server 104 and the client devices 102 in the system 100 are deployed as computer-based devices. Computing devices and their associated hardware, software, and processing capabilities are well known and will not be described in detail here. In this regard, each client device 102 and the server 104 may include, without limitation: at least one processor or processing architecture; a suitable amount of memory; device-specific hardware, software, firmware, and/or applications; a user interface; a communication module; a display element; and additional elements, components, modules, and functionality configured to support various features that are unrelated to the subject matter described here.

A processor used by a device in the system 100 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described here. Moreover, a processor may be implemented as a combination of computing devices, e.g., a combination of a digital signal processor and a microprocessor, a plurality of microprocessors, one or more microprocessors in conjunction with a digital signal processor core, or any other such configuration.

Memory may be realized as RAM memory, flash memory, EPROM memory, EEPROM memory, registers, a hard disk, a removable disk, a CD-ROM, or any other form of storage medium known in the art. In this regard, the memory can be coupled to a processor such that the processor can read information from, and write information to, the memory. In the alternative, the memory may be integral to the processor. As an example, the processor and the memory may reside in an ASIC. The memory can be used to store computer-readable media, where a tangible and non-transient computer-readable medium has computer-executable instructions stored thereon. The computer-executable instructions, when read and executed by the host device, cause the device to perform certain tasks, operations, functions, and processes described in more detail herein. In this regard, the memory may represent one suitable implementation of such computer-readable media. Alternatively or additionally, the device could receive and cooperate with computer-readable media (not separately shown) that is realized as a portable or mobile component or platform, e.g., a portable hard drive, a USB flash drive, an optical disc, or the like.

A communication module used by a device in the system 100 facilitates data communication between the host device and other components as needed during the operation of the device. In the context of this description, a communication module can be employed during a data communication session that includes a client device 102 and the server 104. An embodiment of the device may support wireless data communication and/or wired data communication, using one or more data communication protocols.

For this particular embodiment of the system 100, each client device 102 includes or cooperates with a display element to enable the device to render and display various screens, graphical user interfaces (GUIs) including web pages, drop down menus, auto-fill fields, text entry fields, message fields, or the like. Of course, a display element may also be utilized for the display of other information during the operation of the device, as is well understood.

FIG. 2 is a diagram that schematically depicts an exemplary methodology for generating a semantic footprint from a text-based item. As used herein, a “text-based item” may be any information or content that includes at least some identifiable text. In certain exemplary embodiments, a text-based item may represent some type of user-entered content, such as a message, a comment, a post, a blog entry, or a note entered in the context of interaction with a social networking application. An email, a private message, a report, the content of a web page, an article, a word processing document, a spread sheet document, a user account, a sales opportunity record, or other items that contain text may also be considered to be a text-based item. The non-limiting example described here assumes that the text-based items represent user-entered posts that are maintained by a social networking system.

The methodology depicted in FIG. 2 analyzes the raw or literal text content 202 from a text-based item such as a user-entered post. The text content 202 is processed in an appropriate manner to generate a corresponding semantic footprint 204 for the user-entered post 206. As used herein, a “semantic footprint” characterizes a text-based item using at least some nonliteral contextual association data that need not be linked or otherwise related to any ordinary or usual definition of the literal text content. A semantic footprint of an entity may be considered to be the data that defines it. Thus, a semantic footprint could be made up of structured data and relationships such as the owner of the entity as well as unstructured data such as the keywords that exist in an attachment to the entity. In certain embodiments, it can be structured on a per entity basis into the popular RDF (Resource Description Framework). In this regard, a semantic footprint may consider enterprise-specific, industry-specific, business-specific, or any predefined ontology that provides additional meaning or context to the raw literal text. Consequently, certain words, phrases, clauses, or other word combinations that have particular meaning, special context, or relevance to a given enterprise, business, or group of users can be processed with a heightened level of significance for purposes of generating the semantic footprint 204. Indeed, at least some of the literal text content 202 can be processed to identify corresponding contextual association data, wherein the semantic footprint 204 includes at least some of the identified contextual association data.

The topic extractor 112 of the server 104 (see FIG. 1) is suitably configured to access or obtain the literal text content 202 and generate the resulting semantic footprint 204 that characterizes the text content 202. In accordance with the exemplary embodiment depicted in FIG. 2, the text content 202 may be searched to identify relevant nouns (e.g., people, places, or things) that might be important or significant for purposes of generating the semantic footprint 204. The noun extraction 208 may cooperate with one or more external databases 210 and/or with one or more internal databases 212, where such databases maintain additional contextually significant information, metadata, or other types of descriptive data that are linked or otherwise related to certain extracted nouns. An external database 210 maintains such related information in a manner that is independent of the host system, while an internal database 212 maintains such related information in the context of the host system or social networking application itself. Accordingly, related information maintained by an external database 210 may be more generally known (or public in nature), while related information maintained by an internal database 212 may be restricted, not widely publicized, or have practical contextual meaning only to those who are familiar with the enterprise or network in which the host system is deployed.

As one example, the noun extraction 208 may identify “Jeff Doe” as a person having some contextual significance within the particular enterprise. Moreover, the external database 210 and/or the internal database 212 may provide additional contextual information about Jeff Doe, where such additional contextual information can be used to influence or otherwise generate the semantic footprint 204. For this particular example, the additional contextual information may include any of the following data, without limitation: biographical information regarding Jeff Doe; Jeff Doe's list of contacts or friends; business or career information related to Jeff Doe; etc. It should be appreciated that the databases 210, 212 can be maintained and updated as needed to identify contextual association data corresponding to at least some of the literal text content 202 contained in the text-based items handled by the system 100.

The literal text content 202 of a text-based item may include unstructured data and structured data. As used here, “unstructured data” refers to words that have little to no special or particular meaning above and beyond their normal and ordinary dictionary definitions. In practice, most of the words used in day to day conversation will represent unstructured data. In contrast, “structured data” refers to words, phrases, or word combinations that are linked or otherwise associated with additional information that can be intelligently processed by the system 100. This allows the system 100 to leverage additional information that supplements the literal meaning of the extracted text, for purposes of generating the semantic footprint 204 for the post 206.

For this particular example, the contextual association data may include or represent structured data 214 that has at least some pre-established meaning, definition, or significance known to the host system (e.g., a social networking system). For this reason, FIG. 2 depicts the internal database 212 leading to the structured data 214. In this regard, structured data 214 has some pre-established or predetermined relationship with at least some of the text-based items. For example, structured data 214 may have some pre-established relationship with an author of at least some of the text-based item. As another example, structured data 214 may have some pre-established relationship with an organization or entity to which an author of at least some of the text-based items belongs. Thus, the structured data 214 may include additional information related to an extracted name, an extracted company name, an extracted geographical name (e.g., a city, a country, a state, or a campus location), or the like. In a social networking application, structured data for a user may include, without limitation: the user's avatar; the timestamp of the post 206; a portion of the post 206 that identifies the originator and the recipient by name; the name of a company group, department, or division for the originator (and/or the recipient); the name of a message group or message forum in which the post 206 appears; user profile data; or the like. In practice, this type of structured data is typically captured in the internal database 212 when the post 206 is made. Accordingly, this type of structured data need not be parsed or analyzed by the system 100 with any unstructured data, because the system 100 already has a priori knowledge of the structured data.

As described above, the noun extraction 208 relates to the identification and processing of certain words that have additional meaning or contextual significance associated therewith (via the external database 210 and/or the internal database 212). Some of the extracted nouns may have structured data 214 associated therewith, as depicted in FIG. 2. Typically, the majority of the content of a text-based item will be unstructured data, i.e., “free text” that has no additional contextual information linked thereto. Unstructured data can also be used to generate the semantic footprint of the post 206. In this regard, the system 100 may perform keytext extraction 216 to identify and extract certain keytext (which may be individual words, phrases, names, or a combination of words) from the literal text content 202. Thus, certain designated keytext can be identified, extracted, and processed to obtain the semantic footprint 204. Note that the noun extraction 208 may also be considered to be a form of keytext extraction 216, as both of these extraction routines are performed to identify and extract certain predetermined and specified words. Indeed, the keytext extraction 216 and the noun extraction 208 may cooperate with one or more stored lists of relevant words and phrases maintained by the system 100 for purposes of searching and extraction.

The methodology depicted in FIG. 2 may also utilize an automatic categorization feature 218. The automatic categorization feature 218 may cooperate with one or more ontology databases 220 that maintain and/or extract ontology information to be applied to the text-based items. For example, the database 220 could maintain or generate an enterprise-specific ontology for the enterprise that is responsible for the corpus that includes the text-based items under analysis. Alternatively or additionally, the database 220 could maintain or generate an industry-specific ontology, a user-specific ontology, a group-based ontology, a business-specific ontology, or any desired ontology that can be used to intelligently create the semantic footprint 204 for the post 206. The automatic categorization feature 218 takes advantage of one or more ontology trees to determine whether or not a text-based item or a group of text-based items refers to subjects or topics that may have particular semantic relationships as defined by the ontology trees. For example, a simple ontology tree associated with the automotive industry may be arranged as follows: vehicles>automobiles>brands>models. The ontology trees can be utilized to support the automatic categorization feature 218 for purposes of topic identification. Although ontology trees have been utilized in the past for other applications, the methodology described here employs ontology techniques to support the automatic categorization feature, which in turn influences the generation of the semantic footprint 204, which in turn influences the determination of topic groups for text-based items.

The noun extraction 208, structured data 214, keytext extraction 216, and/or automatic categorization feature 218 can be utilized individually or in any suitable combination to generate, create, or derive the semantic footprint 204 from the literal text content 202 of the post 206. The arrow 224 in FIG. 2 represents one or more steps in the process that generates the semantic footprint 204. It should be appreciated that the semantic footprint for a given post or text-based item may include more or less information, depending upon the amount of literal text content, the amount of structured data maintained by the host system 100, the amount of relevant keytext extracted from the post, whether or not an applicable ontology tree has been leveraged, and other variable factors. The semantic footprint 204 shown in FIG. 2 includes some exemplary and non-limiting information that has been provided for illustrative purposes.

The semantic footprint 204 shown in FIG. 2 includes some information derived from the noun extraction 208, some structured data 214, and some information derived from the keytext extraction 216. For example, the following information may be derived from the noun extraction 208: people 230; company name 232; place 234; and movie 236. As another example, the following information may be associated with structured data 214: post count 238; number of “likes” 240, comments, reputation points, etc.; and a parent organization, group, or account 242. As yet another example, the following information may be derived from the keytext extraction 216: genre 244 (as applied to movies, music, books, or the like); author 246, director, publisher, or producer of content; and other keywords 248. The illustrated semantic footprint 204 also includes information related to hash tags 250 or “@ mentions” that might appear in the post 206. Notably, a given semantic footprint may have more or less data fields and information associated therewith, depending upon the actual content of the literal text and depending on the amount of text contained in the post 206. Thus, a very short post 206 may result in a semantic footprint 204 having only a small amount of additional information. In contrast, a very long post 206 having a detailed enterprise-specific or industry-specific discussion may result in a semantic footprint 204 having multiple information types and having a substantial amount of associated non-literal contextual information.

As one specific example, assume that the post 206 includes the following content:

JOHN DOE to ROB SMITH

Hey Rob. I watched Princess Bride on my flight back from Seattle. Great movie. Thanks for recommending it.

<Yesterday at 10:56 PM>

The semantic footprint for this specific example may include at least some extracted noun information related to people (e.g., John Doe, the originator of the post, and/or Rob Smith, the recipient of the post), a place (e.g., Seattle), and a movie (e.g., “Princess Bride”). The semantic footprint may also include at least some structured data related to the group or account to which John Doe or Rob Smith belongs, the reputation rating for John Doe, and John Doe's post count. The semantic footprint could also leverage one or more ontology trees, such as one associated with the movie industry. Accordingly, the semantic footprint may include at least some information related to the genre, writer, director, actors, or producer of the move “Princess Bride”. Note that the semantic footprint preferably includes at least some non-literal contextual information related to the post, where such non-literal information does not actually appear in the post itself. The topic identification techniques described here leverage this aspect of the semantic footprints to extract and generate topic headings for a plurality of related text-based items.

The semantic paradigm presented here enables the system 100 to generate topics in an intelligent manner that considers the contextual differences of words or phrases that may have different meanings depending upon the user base, the system environment, and/or the social networking audience. For example, consider the following simple text-based items: (1) “I ate an apple today; and (2) “I configured my Apple today”. A traditional keyword based approach might treat the word “apple” identically in these two posts. If, however, the system 100 employs appropriate noun extraction, keytext extrication, and/or an enterprise-based ontology feature, then the semantic footprints of the two posts will highlight the different meanings. Indeed, the footprint for the first post might include information related to “fruit” or “food” derived from the word “apple”, while the footprint for the second post might include information related to “computer” or “company” derived from the word “apple”. Thus, even though the word “apple” is identical in both posts, the system 100 can consider the context, the manner in which the word is being used, the identity and profile information of the poster, the identify and profile information of the recipient, the type of business corresponding to the host enterprise, etc. In this regard, if the poster is defined a priori to be a grocer or a farmer, then “apple” is more likely to be a fruit, whereas if the poster is defined to be a software engineer or a college student, then “apple” is more likely to refer to the well-known company.

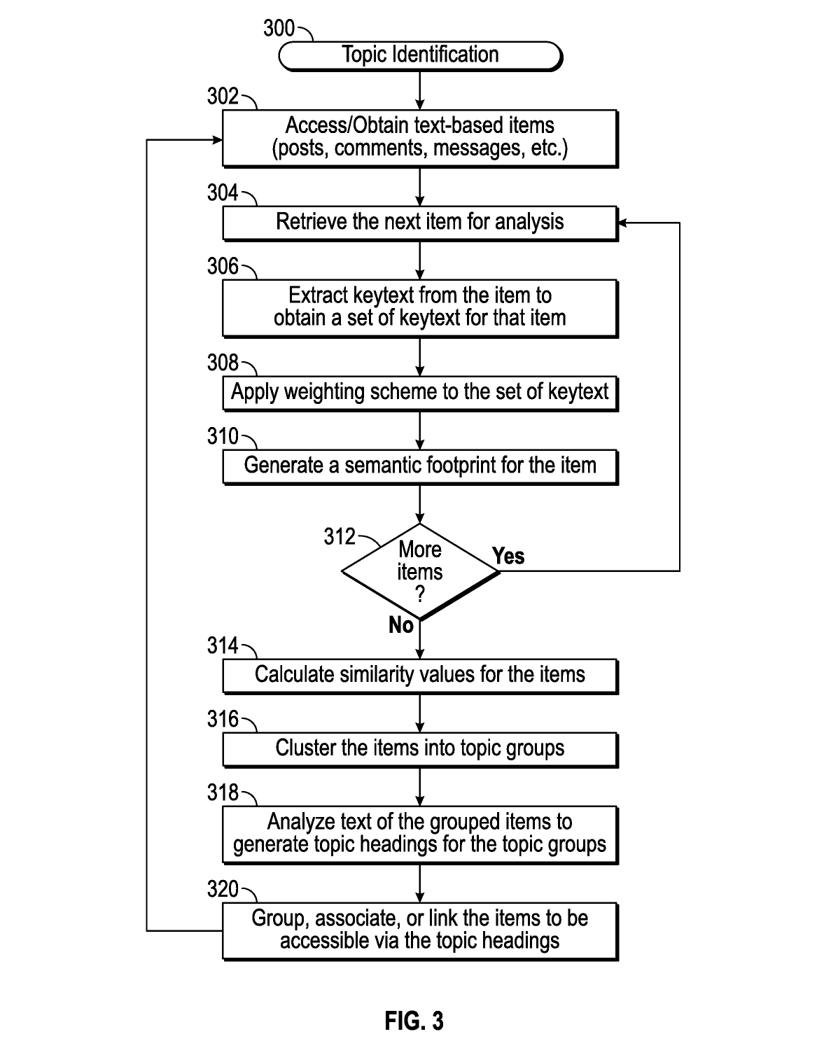

FIG. 3 is a flow chart that illustrates an exemplary embodiment of a topic identification process 300. The various tasks performed in connection with the process 300 may be performed by software, hardware, firmware, or any combination thereof. For illustrative purposes, the following description of the process 300 may refer to elements mentioned above in connection with FIGS. 1 and 2. In certain embodiments, the process 300 is server-based such that it can be performed by the server 104 of the system 100. In this regard, the process 300 represents one exemplary embodiment of a computer-implemented method of identifying topics in a corpus that includes a plurality of text-based items.

It should be appreciated that the process 300 may include any number of additional or alternative tasks, the tasks shown in FIG. 3 need not be performed in the illustrated order, and the process 300 may be incorporated into a more comprehensive procedure or process having additional functionality not described in detail herein. Moreover, one or more of the tasks shown in FIG. 3 could be omitted from an embodiment of the process 300 as long as the intended overall functionality remains intact.

The illustrated embodiment of the process 300 begins by accessing or otherwise obtaining a number of text-based items, which may include any number of user-entered posts, messages, reports, comments, or other content types (task 302). For consistency with the exemplary system embodiment described above, the following description of the process 300 assumes that the text-based items are user-entered posts maintained by a social networking application. The process 300 may utilize the methodology outlined above with reference to FIG. 2 to generate a semantic footprint for each text-based item. Accordingly, the process 300 may retrieve or otherwise access the next text-based item for analysis (task 304).

The process 300 may proceed by searching the literal content of the text-based item to identify and extract keytext from the item (task 306). This keytext extraction step results in a set of keytext for the text-based item under analysis. As mentioned above, the keytext is identified and extracted in accordance with a predetermined list of searchable words, phrases, or word combinations. Moreover, the extracted keytext may be taken from unstructured data as explained above. Although not always required, the process 300 may apply an appropriate weighting scheme to the set of extracted keytext (task 308). This action results in the weighting of the extracted keytext in accordance with the weighting scheme to obtain weighted keytext (where higher weighted keytext has a greater influence on topic identification and lower weighted keytext has less influence on topic identification). Keytext weighting is optional, and the particular weighting scheme may vary from one embodiment to another, and from one deployment to another. If keytext weighting is used, the topics extracted during the process 300 can be influenced by and generated from the weighted keytext.

The process 300 may continue by generating a semantic footprint for the current text-based item (task 310). As mentioned above, the semantic footprint characterizes the corresponding text-based item using at least some nonliteral contextual association data that is somehow related to or linked with the literal text content. Referring again to FIG. 2, the semantic footprint for the current text-based item may be generated by processing extracted noun terms, extracted keytext (weighted or unweighted), structured data associated with extracted nouns terms and/or associated with extracted keytext, and automatic categorization information. Consequently, the semantic footprint may (and preferably does) include at least some contextual association data that is identified for the particular text-based item. In some embodiments, the process 300 utilizes an enterprise-specific ontology (and/or any suitable ontology) to generate the semantic footprint for the text-based item. Ultimately, the semantic footprint for a given text-based item can provide more contextual meaning and significance within an enterprise environment, relative to the raw literal text content alone.

The process 300 generates a semantic footprint for a plurality of the text-based items in the corpus. Thus, if more items remain for analysis (the “Yes” branch of query task 312), then the process 300 returns to task 304 to retrieve the next item for processing. Otherwise, the process 300 continues, with the intended goal of identifying topic groups for the analyzed items. For example, the process 300 may use the semantic footprints to calculate similarity values for the text-based items (task 314). As used here, a “similarity value” is a measure or a metric that indicates an amount, extent, or level of commonality between a pair of text-based items. For example, two identical text-based items will have a similarity value at one end of the scale (e.g., a maximum value of 1.0), while two completely different text-based items with nothing in common will have a similarity value at the other end of the scale (e.g., a minimum value of 0.0). Theoretically, the process 300 can generate a similarity value for each possible pair of text-based items (assuming that semantic footprints for the items have been created). In practice, however, the process 300 need not generate all of the possible similarity values. Referring again to task 308, if a weighting scheme is utilized to weight the extracted keytext, then the similarity values could be calculated from or otherwise influenced by the weighted keytext.

Rather than compare only the literal text content of the text-based items, the process 300 calculates the similarity values based on the semantic footprints of the items. In other words, the measure of similarity is influenced by certain non-literal contextual meaning that has been assigned to the various text-based items. This approach is particularly desirable in an enterprise environment where the volume of text-based items may not be large enough to effectively and reliably generate topics using a traditional statistical methodology. In practice, task 314 may result in a similarity graph, chart, or other logical construct that can be reviewed or otherwise processed to cluster the text-based items into one or more topic groups (task 316). The clustering performed during task 316 may leverage one or more known techniques or approaches. For example, task 316 may utilize the DBSCAN data clustering algorithm or any suitable data clustering model as appropriate to the particular embodiment.

Thus, the process 300 can cluster the text-based items into a number of potential topic groups, wherein the clustering is influenced by the similarity values calculated during task 314. It should be appreciated that a given text-based item in the corpus under analysis need not be included in any topic group or cluster. Moreover, a given text-based item could ultimately be designated as a member of only one topic group or a member of a plurality of different topic groups. In accordance with one simplified embodiment, the process 300 utilizes one or more similarity value thresholds to cluster the items into the topic groups. For example, the process 300 may consider 0.75 to be the threshold similarity value for purposes of designating potential topic groups. Thus, any pair of text-based items having a similarity value less than 0.75 will not be treated as being part of a common topic group. In contrast, pairs of text-based items having a similarity value greater than or equal to 0.75 will be included in a common topic group. Accordingly, if a plurality of items are “clustered” together based on their respective similarity values, then those items are likely to be related to common subject matter and, therefore, suitable for grouping. In contrast, if items are “spread apart” based on their similarity values, then those items are less likely to be related to a similar topic and, therefore, they should not be grouped together.

After clustering in the manner described above, the process 300 may continue to analyze the text-based items in each topic group in an attempt to identify or designate the common topic (or topics) within each topic group. This procedure may be referred to herein as “topic extraction” because the goal is to identify and extract one or more topics for the analyzed text-based items. In certain embodiments, the process 300 analyzes the literal text of the grouped or clustered items to identify and generate the applicable topic headings to be used for the different topic groups (task 318). For example, task 318 may search the individual items within a group to identify and extract relevant or significant keywords or phrases that appear frequently within the group. Such identified text could then be used to create the topic heading text for that particular group. Notably, the keytext extraction, ontology, automatic categorization, and/or keyword extraction techniques described above could also be leveraged for purposes of topic extraction. For instance, an enterprise-specific ontology could be utilized to generate topic headings for text-based items maintained by a particular enterprise or social networking system.

In addition, the process 300 may group, associate, or otherwise link the text-based items into accessible topic groups that in turn are associated with the different topic headings (task 320). In other words, the process 300 can create appropriate database links or relationships to designate topic group membership among the various text-based items. In accordance with one embodiment that renders the topic headings as active links, the text-based items corresponding to a given topic heading can be accessed via the topic heading (e.g., in response to user selection of the active link for the topic heading).

FIG. 3 depicts task 320 leading back to task 302, to indicate the ongoing nature of the process 300. In other words, the topic extraction routine can be performed in an ongoing manner to update, modify, or otherwise alter the topic groups, revise the topic headings, add or delete topic groups, etc. Using the approach outlined above, semantic footprints can be analyzed in an appropriate manner to identify a plurality of topic groups for the text-based items, wherein the topic groups are identified in response to the clustering performed during task 316. The system 100 may perform additional tasks (not shown in FIG. 3) if desired to supplement or enhance the user experience. For example, the process 300 may identify user experts for each of the identified topic groups. In this context, a “user expert” may be defined to be any user of the system 100 that contributes significantly to an identified topic, a user that has a relatively large number of “likes” or “@mentions” associated with a given topic, or the like. As another example, the process 300 may identify which (if any) of the identified topics are currently trending, popular, or “hot” based on any number of metrics, as is well understood.

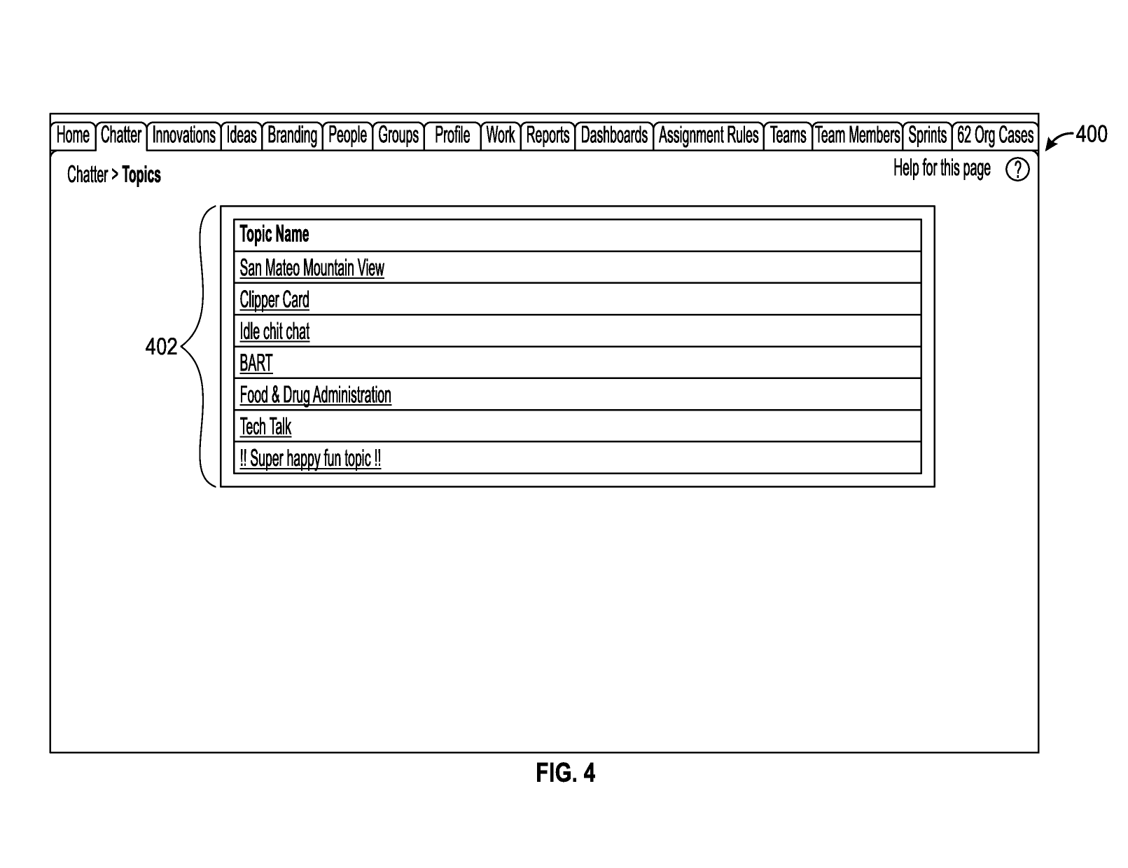

FIG. 4 is a schematic rendering of a screen shot 400 that includes a list of selectable topic headings 402. Although not always required, the screen shot 400 corresponds to a web page generated by an enterprise-based social networking application. For this particular embodiment, each entry in the list of selectable topic headings 402 is rendered as an active link that points to a respective web page that contains the text-based items categorized under that particular topic heading. In practice, therefore, each of the selectable topic headings can be associated with a uniform resource identifier (URI), as is well understood. This non-limiting example includes the following topic headings: San Mateo Mountain View; Clipper Card; Idle Chit Chat; BART; Food & Drug Administration; Tech Talk; and Super Happy Fun Topic.

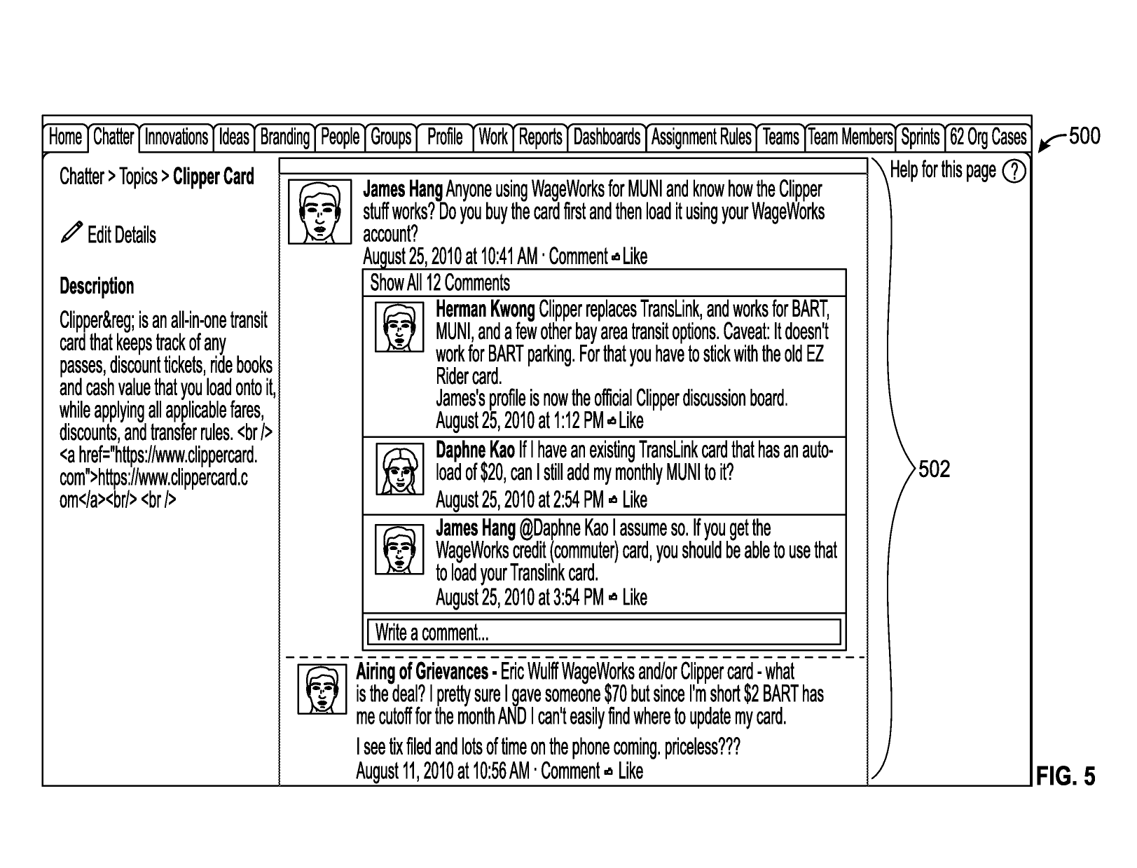

FIG. 5 is a schematic rendering of a screen shot 500 that includes a group of posts 502 associated with a selected topic, namely, the Clipper Card topic shown in FIG. 4. Thus, the screen shot 500 may correspond to a web page that is provided and displayed in response to selection of the active link titled Clipper Card, and the web page includes at least some of the text-based items (e.g., user-entered posts) that have been identified as being relevant to the Clipper Card topic. Posts that are collected under a given topic in this manner may be edited, deleted, responded to, “liked”, and/or otherwise operated on in a conventional manner, as is well understood.

The exemplary embodiments presented here relate to various computer-implemented and computer-executed techniques related to the processing of text-based items and to the generation of topic groups for the items. The described subject matter could be implemented in connection with any suitable computer-based architecture, system, network, or environment, such as two or more user devices that communicate via a data communication network. Although the subject matter presented here could be utilized in connection with any type of computing environment, certain exemplary embodiments can be implemented in conjunction with a multi-tenant database environment.

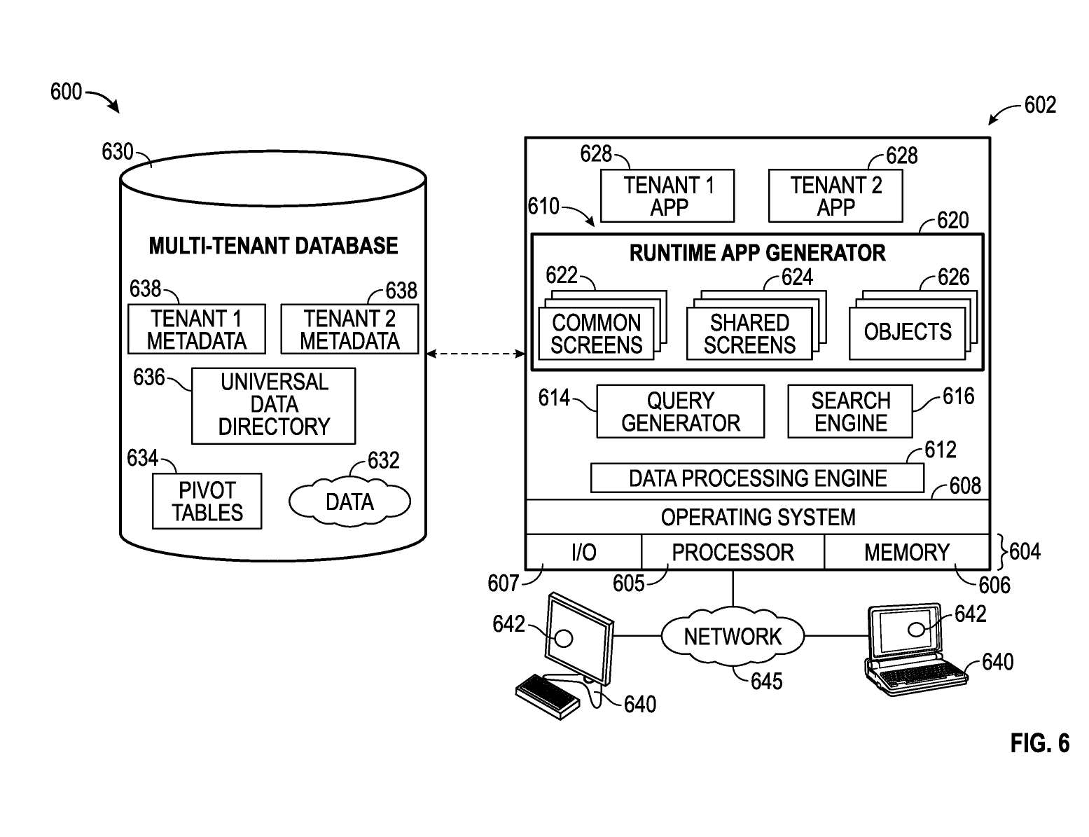

In this regard, an exemplary embodiment of a multi-tenant application system 600 is shown in FIG. 6. The system 600 suitably includes a server 602 that dynamically creates virtual applications 628 based upon data 632 from a common database 630 that is shared between multiple tenants. Data and services generated by the virtual applications 628 are provided via a network 645 to any number of user devices 640, as desired. Each virtual application 628 is suitably generated at run-time using a common application platform 610 that securely provides access to the data 632 in the database 630 for each of the various tenants subscribing to the system 600. In accordance with one non-limiting example, the system 600 may be implemented in the form of a multi-tenant CRM system that can support any number of authenticated users of multiple tenants.

A “tenant” or an “organization” generally refers to a group of users that shares access to common data within the database 630. Tenants may represent customers, customer departments, business or legal organizations, and/or any other entities that maintain data for particular sets of users within the system 600. Although multiple tenants may share access to the server 602 and the database 630, the particular data and services provided from the server 602 to each tenant can be securely isolated from those provided to other tenants. The multi-tenant architecture therefore allows different sets of users to share functionality without necessarily sharing any of the data 632.

The database 630 is any sort of repository or other data storage system capable of storing and managing the data 632 associated with any number of tenants. The database 630 may be implemented using any type of conventional database server hardware. In various embodiments, the database 630 shares processing hardware 604 with the server 602. In other embodiments, the database 630 is implemented using separate physical and/or virtual database server hardware that communicates with the server 602 to perform the various functions described herein.

The data 632 may be organized and formatted in any manner to support the application platform 610. In various embodiments, the data 632 is suitably organized into a relatively small number of large data tables to maintain a semi-amorphous “heap”-type format. The data 632 can then be organized as needed for a particular virtual application 628. In various embodiments, conventional data relationships are established using any number of pivot tables 634 that establish indexing, uniqueness, relationships between entities, and/or other aspects of conventional database organization as desired.

Further data manipulation and report formatting is generally performed at run-time using a variety of metadata constructs. Metadata within a universal data directory (UDD) 636, for example, can be used to describe any number of forms, reports, workflows, user access privileges, business logic and other constructs that are common to multiple tenants. Tenant-specific formatting, functions and other constructs may be maintained as tenant-specific metadata 638 for each tenant, as desired. Rather than forcing the data 632 into an inflexible global structure that is common to all tenants and applications, the database 630 is organized to be relatively amorphous, with the pivot tables 634 and the metadata 638 providing additional structure on an as-needed basis. To that end, the application platform 610 suitably uses the pivot tables 634 and/or the metadata 638 to generate “virtual” components of the virtual applications 628 to logically obtain, process, and present the relatively amorphous data 632 from the database 630.

The server 602 is implemented using one or more actual and/or virtual computing systems that collectively provide the dynamic application platform 610 for generating the virtual applications 628. The server 602 operates with any sort of conventional processing hardware 604, such as a processor 605, memory 606, input/output features 607 and the like. The processor 605 may be implemented using one or more of microprocessors, microcontrollers, processing cores and/or other computing resources spread across any number of distributed or integrated systems, including any number of “cloud-based” or other virtual systems. The memory 606 represents any non-transitory short or long term storage capable of storing programming instructions for execution on the processor 605, including any sort of random access memory (RAM), read only memory (ROM), flash memory, magnetic or optical mass storage, and/or the like. The server 602 typically includes or cooperates with some type of computer-readable media, where a tangible computer-readable medium has computer-executable instructions stored thereon. The computer-executable instructions, when read and executed by the server 602, cause the server 602 to perform certain tasks, operations, functions, and processes described in more detail herein. In this regard, the memory 606 may represent one suitable implementation of such computer-readable media. Notably, the processor 605 and the memory 606 may be suitably configured to carry out the various topic extraction operations described above. Indeed, the server 602 represents one exemplary embodiment of the server 104 shown in FIG. 1.

The input/output features 607 represent conventional interfaces to networks (e.g., to the network 645, or any other local area, wide area or other network), mass storage, display devices, data entry devices and/or the like. In a typical embodiment, the application platform 610 gains access to processing resources, communications interfaces and other features of the processing hardware 604 using any sort of conventional or proprietary operating system 608. As noted above, the server 602 may be implemented using a cluster of actual and/or virtual servers operating in conjunction with each other, typically in association with conventional network communications, cluster management, load balancing and other features as appropriate.

The application platform 610 is any sort of software application or other data processing engine that generates the virtual applications 628 that provide data and/or services to the user devices 640. The virtual applications 628 are typically generated at run-time in response to queries received from the user devices 640. For the illustrated embodiment, the application platform 610 includes a bulk data processing engine 612, a query generator 614, a search engine 616 that provides text indexing and other search functionality, and a runtime application generator 620. Each of these features may be implemented as a separate process or other module, and many equivalent embodiments could include different and/or additional features, components or other modules as desired.

The runtime application generator 620 dynamically builds and executes the virtual applications 628 in response to specific requests received from the user devices 640. The virtual applications 628 created by tenants are typically constructed in accordance with the tenant-specific metadata 638, which describes the particular tables, reports, interfaces and/or other features of the particular application. In various embodiments, each virtual application 628 generates dynamic web content (including GUIs, detail views, secondary or sidebar views, and the like) that can be served to a browser or other client program 642 associated with its user device 640, as appropriate.

The runtime application generator 620 suitably interacts with the query generator 614 to efficiently obtain multi-tenant data 632 from the database 630 as needed. In a typical embodiment, the query generator 614 considers the identity of the user requesting a particular function, and then builds and executes queries to the database 630 using system-wide metadata 636, tenant specific metadata 638, pivot tables 634, and/or any other available resources. The query generator 614 in this example therefore maintains security of the common database 630 by ensuring that queries are consistent with access privileges granted to the user that initiated the request.

The data processing engine 612 performs bulk processing operations on the data 632 such as uploads or downloads, updates, online transaction processing, and/or the like. In many embodiments, less urgent bulk processing of the data 632 can be scheduled to occur as processing resources become available, thereby giving priority to more urgent data processing by the query generator 614, the search engine 616, the virtual applications 628, etc. In certain embodiments, the data processing engine 612 and the processor 605 cooperate in an appropriate manner to perform and manage various techniques, processes, and methods associated with the handling of text-based items and the associated extraction of topics for those items, as described previously with reference to FIGS. 1-5.

In operation, developers use the application platform 610 to create data-driven virtual applications 628 for the tenants that they support. Such virtual applications 628 may make use of interface features such as tenant-specific screens 624, universal screens 622 or the like. Any number of tenant-specific and/or universal objects 626 may also be available for integration into tenant-developed virtual applications 628. The data 632 associated with each virtual application 628 is provided to the database 630, as appropriate, and stored until it is requested or is otherwise needed, along with the metadata 638 that describes the particular features (e.g., reports, tables, functions, etc.) of that particular tenant-specific virtual application 628. For example, a virtual application 628 may include a number of objects 626 accessible to a tenant, wherein for each object 626 accessible to the tenant, information pertaining to its object type along with values for various fields associated with that respective object type are maintained as metadata 638 in the database 630. In this regard, the object type defines the structure (e.g., the formatting, functions and other constructs) of each respective object 626 and the various fields associated therewith. In an exemplary embodiment, each object type includes one or more fields for indicating the relationship of a respective object of that object type to one or more objects of a different object type (e.g., master-detail, lookup relationships, or the like).

In exemplary embodiments, the application platform 610, the data processing engine 612, the query generator 614, and the processor 605 cooperate in an appropriate manner to process data associated with a hosted virtual application 628 (such as a CRM application), generate and provide suitable GUIs (such as web pages) for presenting data on client devices 640, and perform additional techniques, processes, and methods to support the features and functions related to the provision of messaging features and functions for the hosted virtual application 628.

Still referring to FIG. 6, the data and services provided by the server 602 can be retrieved using any sort of personal computer, mobile telephone, portable device, tablet computer, or other network-enabled user device 640 that communicates via the network 645. Typically, the user operates a conventional browser or other client program 642 to contact the server 602 via the network 645 using, for example, the hypertext transport protocol (HTTP) or the like. The user typically authenticates his or her identity to the server 602 to obtain a session identifier (“SessionID”) that identifies the user in subsequent communications with the server 602. When the identified user requests access to a virtual application 628, the runtime application generator 620 suitably creates the application at run time based upon the metadata 638, as appropriate. The query generator 614 suitably obtains the requested data 632 from the database 630 as needed to populate the tables, reports or other features of the particular virtual application 628. As noted above, the virtual application 628 may contain Java, ActiveX, or other content that can be presented using conventional client software running on the user device 640; other embodiments may simply provide dynamic web or other content that can be presented and viewed by the user, as desired.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a tangible non-transitory processor-readable medium in certain embodiments. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, or the like.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method of identifying topics in a corpus that includes a plurality of text-based items, the method comprising:
extracting keytext from each of the plurality of text-based items, resulting in a plurality of keytext sets;
processing the plurality of keytext sets to generate a respective semantic footprint for each of the plurality of text-based items, resulting in a plurality of semantic footprints;
using the plurality of semantic footprints to calculate similarity values for the plurality of text-based items, wherein the similarity values indicate commonality between pairs of the text-based items;
clustering the plurality of text-based items into a number of topic groups, wherein the clustering is influenced by the similarity values;
generating a topic heading for each of the number of topic groups, resulting in a number of topic headings; and
grouping the plurality of text-based items into accessible topic groups associated with the topic headings.

2. The method of claim 1, further comprising:
weighting the extracted keytext in accordance with a predetermined weighting scheme to obtain weighted keytext;
wherein the plurality of semantic footprints is generated from the weighted keytext.

3. The method of claim 1, further comprising:
weighting the extracted keytext in accordance with a predetermined weighting scheme to obtain weighted keytext;
wherein the similarity values are calculated from the weighted keytext.

4. The method of claim 1, wherein generating a topic heading for each of the number of topic groups comprises:
identifying text contained in the text-based items in each of the number of topic groups; and
creating the topic heading from the identified text.

5. The method of claim 1, further comprising:
identifying user experts for each of the number of topic groups.

6. The method of claim 1, wherein the plurality of text-based items comprises a plurality of user-entered posts maintained by a social networking system.

7. The method of claim 1, wherein processing the plurality of keytext sets comprises:
processing at least some literal text taken from the plurality of keytext sets to identify contextual association data corresponding to the literal text;
wherein the plurality of semantic footprints include at least some of the identified contextual association data.

8. The method of claim 7, wherein the contextual association data comprises structured data having some pre-established relationship with at least some of the text-based items.

9. The method of claim 8, wherein the structured data has a pre-established relationship with an author of at least some of the text-based items.

10. The method of claim 8, wherein the structured data has a pre-established relationship with an organization to which an author of at least some of the text-based items belongs.

11. The method of claim 1, further comprising:
maintaining an enterprise-specific ontology for an enterprise responsible for the corpus;
wherein processing the plurality of keytext sets utilizes the enterprise-specific ontology to generate the plurality of semantic footprints.

12. The method of claim 1, further comprising:
maintaining an enterprise-specific ontology for an enterprise responsible for the corpus;
wherein generating the topic heading utilizes the enterprise-specific ontology to generate the number of topic headings.

13. A computer-implemented method of identifying topics in a corpus that includes a plurality of text-based items, the method comprising:
generating, for each of the plurality of text-based items, a respective semantic footprint that characterizes its corresponding text-based item using at least some nonliteral contextual association data, resulting in a plurality of semantic footprints;
calculating similarity values for the plurality of text-based items, wherein the similarity values are calculated from the plurality of semantic footprints, and wherein each of the similarity values indicates a measure of commonality between a respective pair of the plurality of text-based items;
clustering the plurality of text-based items in accordance with the similarity values; and
identifying a topic group for the plurality of text-based items in response to the clustering.

14. The method of claim 13, further comprising:
extracting keytext from each of the plurality of text-based items;
wherein the respective semantic footprint for each of the plurality of text-based items is generated based at least upon the extracted keytext.

15. The method of claim 13, further comprising:
grouping at least some of the plurality of text-based items into the topic group, resulting in topic-specified text-based items;
identifying contextually significant text contained in the topic-specified text-based items; and
creating, from the identified contextually significant text, a topic heading for the topic group.

16. The method of claim 13, wherein the plurality of text-based items comprises a plurality of user-entered content maintained by a social networking system.

17. The method of claim 16, wherein the nonliteral contextual association data comprises structured data having some pre-established meaning known to the social networking system.

18. A computer-readable medium having computer-executable instructions that, when executed by a processor, perform a method of identifying topics in a corpus that includes a plurality of text-based items, the method comprising:
generating, for each of the plurality of text-based items, a respective semantic footprint that characterizes its corresponding text-based item using at least some nonliteral contextual association data, resulting in a plurality of semantic footprints; and
analyzing the plurality of semantic footprints to identify a plurality of topic groups for the plurality of text-based items.

19. The computer-readable medium of claim 18, wherein the method performed by the computer-executable instructions further comprises
calculating similarity values for the plurality of text-based items, wherein the similarity values are calculated from the plurality of semantic footprints, and wherein each of the similarity values indicates a measure of commonality between a respective pair of the plurality of text-based items; and
clustering the plurality of text-based items in accordance with the similarity values;
wherein the topic groups are identified in response to the clustering.

20. The computer-readable medium of claim 18, wherein the method performed by the computer-executable instructions further comprises:
extracting keytext from each of the plurality of text-based items;
wherein the respective semantic footprint for each of the plurality of text-based items is generated based at least upon the extracted keytext.
